(19) United States
(12) Patent Application Publication
(10) Pub. No.: US 2025/0135477 A1
(43) Pub. Date: May 1, 2025

(54) APERTURE-ADJUSTABLE MIXED-FLOW NOZZLE AND ITS ATOMIZATION METHOD

(71) Applicant: SHANDONG UNIVERSITY OF SCIENCE AND TECHNOLOGY

(72) Inventors: Haiming YU, Qingdao (CN); Xu LI, Qingdao (CN); Weimin CHENG, Qingdao (CN); Yao XIE, Qingdao (CN); Wang LI, Qingdao (CN)

(21) Appl. No.: 18/735,092

(22) Filed: Jun. 5, 2024

(30) Foreign Application Priority Data
Oct. 25, 2023 (CN) 202311392574.3

(51) Int. Cl. B05B 7/00; E21F 5/02

(52) U.S. Cl. CPC B05B 7/0075; E21F 5/02

(57) ABSTRACT

Disclosed are an aperture-adjustable mixed-flow nozzle and its atomization method. The nozzle includes a cylindrical shell with an airflow chamber and a mixed-flow chamber. The airflow chamber is connected to an air inlet, and the mixed-flow chamber is connected to a liquid inlet. An nozzle is provided at the bottom wall of the mixed-flow chamber on the cylindrical shell. The cylindrical shell allows airflow from the airflow chamber to enter the mixed-flow chamber through an adjusting shaft. A swirling flow path is disposed around the outer periphery of the adjusting shaft, and a gas path for connecting the airflow chamber and the mixed-flow chamber is disposed inside the adjusting shaft. By adjusting the nozzle aperture size, not only is the problem of nozzle blockage resolved, but it also allows for control of atomization effects and spray field conditions, making it more effective for complex dust-producing environments on-site.

### CROSS-REFERENCE TO RELATED APPLICATIONS

This application claims priority to Chinese Application No. 202311392574.3, filed on Oct. 25, 2023, entitled “APERTURE-ADJUSTABLE MIXED-FLOW NOZZLE AND ITS ATOMIZATION METHOD”. These contents are hereby incorporated by reference.

### TECHNICAL FIELD

The present disclosure relates to the technical field of mechanical, relating to a jet spray nozzle dust removal device, in particular to an aperture-adjustable mixed-flow nozzle and its atomization method.

### BACKGROUND

With the continuous improvement of mechanization, automation, and intelligence levels in coal mining, the annual coal production has been steadily increasing. Dust is one of the five major hazards in coal mines. The deployment of large-scale mechanical mining equipment in coal mines has resulted in increased dust-producing intensity and volume. High-concentration dust not only triggers coal dust explosions but also leads to an elevated incidence of diseases such as pneumoconiosis. Dust reduction has become a crucial and urgent problem that needs to be addressed in underground coal mines.

Dust removal by spraying, as a typical dust removal technology, is widely used in dust-producing areas at different underground mining locations. However, the atomization effect of nozzles is a crucial factor influencing dust reduction efficiency. The atomization effect of existing nozzles is generally poor, especially under low-pressure conditions where atomization is less effective. Under low-pressure conditions, the droplet particle size after atomization is larger, with low fragmentation. The spray field is easily dispersed, leading to a lower collision and aggregation efficiency between jet spray droplets and dust, resulting in unsatisfactory dust reduction efficiency.

Additionally, nozzles are prone to clogging during use, leading to a decrease in dust reduction efficiency. It is challenging to promptly clear the blocked material, and the problem can only be solved by replacing the nozzle, which incurs high replacement costs. Furthermore, it is also difficult to effectively adjust the spray field condition of the nozzle during use, resulting in poor applicability.

### SUMMARY

The objective of the present disclosure is to address the aforementioned issues in the existing technology. It proposes an aperture-adjustable mixed-flow nozzle and its atomization method that utilizes the extension and retraction of the adjusting shaft to regulate the flow rate of the gas-liquid mixture, thereby eliminating blockages and adjusting the spray field condition.

The objective of the present disclosure is achieved through the following technical solution: An aperture-adjustable mixed-flow nozzle, including a cylindrical shell with an airflow chamber and a mixed-flow chamber that are separated at top and bottom, the airflow chamber is connected to an air inlet, and the mixed-flow chamber is connected to a liquid inlet, wherein an nozzle is provided at a bottom wall of the mixed-flow chamber on the cylindrical shell; the cylindrical shell allows airflow from the airflow chamber to enter the mixed-flow chamber through an adjusting shaft; a swirling flow path is disposed around an outer periphery of the adjusting shaft, and a gas path for connecting the airflow chamber and the mixed-flow chamber is disposed inside the adjusting shaft; the adjusting shaft is axially adjustable by extension and retraction along the cylindrical shell; and a locking assembly is provided between the adjusting shaft and the cylindrical shell.

In the aforementioned aperture-adjustable mixed-flow nozzle, the cylindrical shell is internally separated by a baffle plate to form the airflow chamber and the mixed-flow chamber; a first socket is arranged at a top wall of the airflow chamber on the cylindrical shell, and a second socket is correspondingly arranged on the baffle plate; and the adjusting shaft is connected with the first socket and the second socket in sequence to form a thread engagement assembly.

In the aforementioned aperture-adjustable mixed-flow nozzle, the mixed-flow chamber comprises a cylindrical chamber and a conical chamber that are interconnected with each other, with a small end of the conical chamber being connected to the nozzle; a bottom of the adjusting shaft is a conical-shaped bottom end, with a separating needle solidly disposed at the conical-shaped bottom end, and the separating needle extends from a small end of the conical chamber to the nozzle.

In the aforementioned aperture-adjustable mixed-flow nozzle, the air inlet is vertically disposed on one side of the cylindrical shell orthogonal to the axis of the cylinder shell, the liquid inlet is disposed on the other side of the cylindrical shell aligned to a tangential direction of the adjusting shaft, a top end of the gas path is bent to connect to the airflow chamber, and a bottom end of the gas path is connected to the mixed-flow chamber through a forked path.

In the aforementioned aperture-adjustable mixed-flow nozzle, the swirling flow path is a groove helically provided around the outer periphery of the adjusting shaft, and a lower end of the swirling flow path is disposed above the forked path.

In the aforementioned aperture-adjustable mixed-flow nozzle, the locking assembly includes a fixing screw, a fixing plate provided at a top of the adjusting shaft, a fixing hole provided on the fixing plate, and a plurality of threaded holes provided on a top wall of the cylindrical shell; the fixing screw successively crosses through the fixing hole and the threaded holes from top to bottom to form a thread engagement for locking.

In the aforementioned aperture-adjustable mixed-flow nozzle, a magnet is disposed at a bottom of the threaded holes, and the magnet is fixed with the fixing screw through magnetic attraction.

In the aforementioned aperture-adjustable mixed-flow nozzle, a flow gather hood is disposed on an outer side of the cylindrical shell at the nozzle; the flow gather hood is conical-shaped and gradually expands downward from the cylinder shell; and a plurality of negative pressure suction ports with a trapezoidal shape are arranged on the outer wall of the flow gather hood.

The atomization method of the aperture-adjustable mixed-flow nozzle includes the following steps:
S1. introducing air through an air inlet to allow the air flowing from an airflow chamber into the gas path and entering a mixed-flow chamber through a forked path; introducing high-pressure water through a liquid inlet to allow the high-pressure water entering the mixed-flow chamber along a tangent line and being spiral descent guided by a swirling flow path; mixing the high-pressure water and the air thoroughly at between a conical-shaped bottom end of an adjusting shaft and a conical chamber of the mixed-flow chamber; increasing a shearing force between gas and liquid through an inclined ejection angle of the air and a swirling angle of the high-pressure water, leading to gas-liquid atomization to form a jet spray droplets, and then ejecting the jet spray droplets through a nozzle;
S2. if a flow passage between the conical-shaped bottom end of the adjusting shaft and the conical chamber of the mixed-flow chamber is blocked by debris, pulling out the fixing screw through external force first, then rotating the adjusting shaft to move the adjusting shaft upward along the axis of the cylinder shell, gradually increasing a distance between the conical-shaped bottom end and the conical chamber, synchronously increasing the cross-sectional area of an annular conical channel, increasing a flow rate of the air and the high-pressure water, and then increasing a impact force to break through the debris, playing a role in unblocking and preventing blockage;
S3. pulling out the fixing screw with external force first when the atomization effect and the spray field condition are required to alter; then, rotating the adjusting shaft to move the adjusting shaft along its axis to adjust a flow rate of gas-liquid mixture to correspondingly modify air and water consumption, a spray pattern, and the atomization effect until a desired outcome is achieved; finally, reinserting the fixing screw to secure and lock position.

In the atomization method of the aforementioned-mentioned aperture-adjustable mixed-flow nozzle, in step S1, the jet spray droplets pass through the flow gather hood to form an umbrella-shaped jet constraint spray; the surrounding dust-containing airflow enters the flow gather hood through the negative pressure suction ports, the dust-containing airflow combines with the spray field to cause a collision of dust and jet spray droplets, and dust particles are moistened and gain weight, undergoing sedimentation under an influence of gravity, so as to achieve dust removal.

Compared with existing technology, the present aperture-adjustable mixed-flow nozzle and its atomization method have the following advantageous effects:
1. By using gas-liquid two-phase mixing and centrifugal rotation, the atomization effect of the nozzle is enhanced. Air and water are introduced into the nozzle, and the water undergoes centrifugal rotation and atomizes under the disturbance of the airflow, increasing kinetic energy.
2. By providing a flow gather hood on the outside of the nozzle to effectively constrain the pattern of the spray field, it can reduce the ineffective spray fields caused by wind disturbance of low-concentration droplets around the spray field. Besides, through the negative pressure formed by the high-speed spray field, a large amount of dusty airflow from the suction port is drawn in, purifying the polluted air near the nozzle.
3. By changing the nozzle aperture size, the present disclosure can not only solve the problem of nozzle blockage, but also control the atomization effect and the spray field condition, making it more effective for complex dust-producing environments on site.

In summary, this nozzle structure not only has the characteristics of adjustable atomization effect, adjustable water consumption, and low maintenance costs but also has the advantage of high dust removal efficiency.

### BRIEF DESCRIPTION OF THE DRAWINGS

FIG. 1 is a sectional structural diagram of the aperture-adjustable mixed-flow nozzle.

FIG. 2 is an external structural diagram of the aperture-adjustable mixed-flow nozzle.

FIG. 3 is a three-dimensional structural diagram of the adjusting shaft in the aperture-adjustable mixed-flow nozzle.

The reference numbers in the figures: 1. cylindrical shell; 2. air inlet; 3. airflow chamber; 4. liquid inlet; 5. mixed-flow chamber; 6. nozzle; 7. adjusting shaft; 8. gas path; 9. swirling flow path; 10. fixing screw; 11. magnet; 12. conical hood; 13. negative pressure suction port.

### DETAILED DESCRIPTION OF THE EMBODIMENTS

The specific implementation method of the present disclosure is further illustrated below in conjunction with the drawings and specific embodiments:

### Embodiment 1

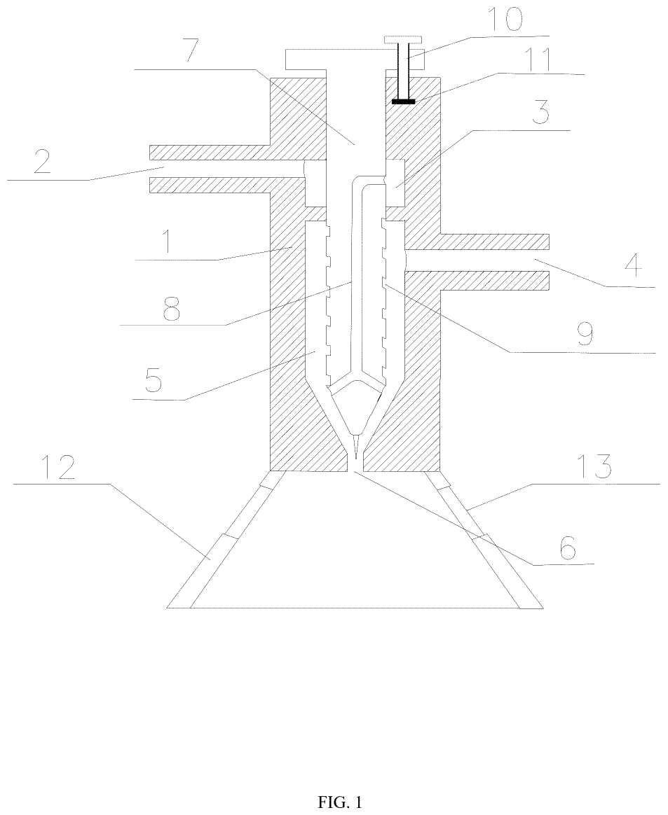

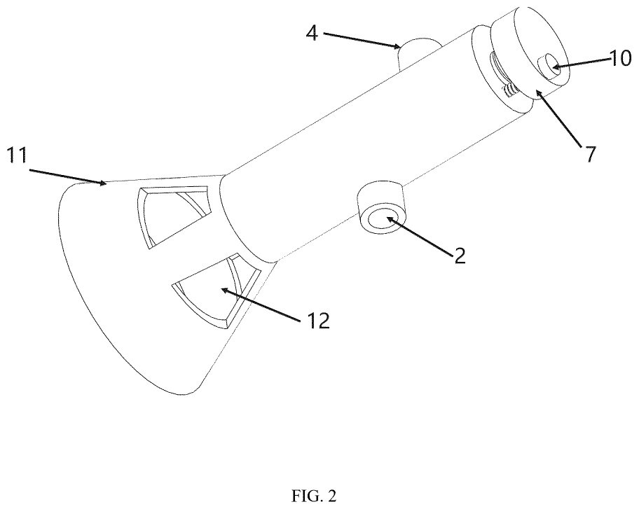

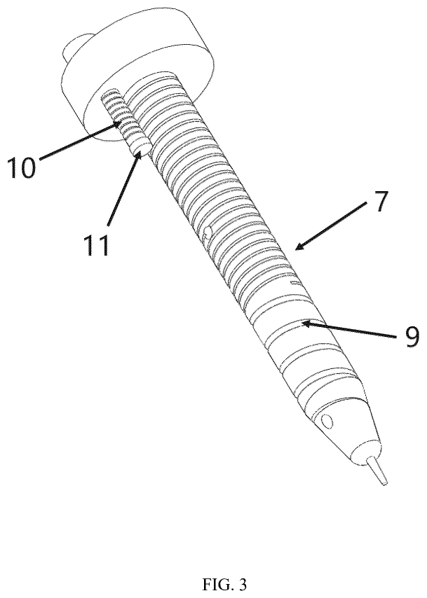

As shown in FIGS. 1 to 3, an aperture-adjustable mixed-flow nozzle, including a cylindrical shell 1 with an airflow chamber 3 and a mixed-flow chamber 5 that are separated at top and bottom. The airflow chamber 3 is connected to an air inlet 2, and the mixed-flow chamber 5 is connected to a liquid inlet 4. An nozzle 6 is provided at the bottom wall of the mixed-flow chamber 5 on the cylindrical shell 6. The cylindrical shell 1 allows airflow from the airflow chamber 3 to enter the mixed-flow chamber 5 through an adjusting shaft 7, a swirling flow path 9 is disposed around the outer periphery of the adjusting shaft 7, and a gas path 8 for connecting the airflow chamber 3 and the mixed-flow chamber 5 is disposed inside the adjusting shaft 5. The adjusting shaft 7 is axially adjustable by extension and retraction along the cylindrical shell 1, and a locking assembly is provided between the adjusting shaft 7 and the cylindrical shell 1.

The cylindrical shell 1 is internally separated by a baffle plate to form the airflow chamber 3 and the mixed-flow chamber 5. A first socket is arranged at the top wall of the airflow chamber on the cylindrical shell 1, and a second socket is correspondingly arranged on the baffle plate, and the adjusting shaft 7 is connected with the first socket and the second socket in sequence to form a thread engagement assembly. The first socket and the second socket are threaded through holes with equal diameters. The outer circumference of the upper half of the adjusting shaft 7 is equipped with external threads, not only can rotationally adjust the extension and retraction position of the adjusting shaft 7 through thread fit, but also realize the sealed isolation between the airflow chamber 3 and the mixed-flow chamber 5 through thread engagement.

The mixed-flow chamber 5 includes a cylindrical chamber and a conical chamber that are interconnected with each other, with the small end of the conical chamber being connected to the nozzle. The bottom of the adjusting shaft 7 is a conical-shaped bottom end, with a separating needle solidly disposed at the conical-shaped bottom end, and the separating needle extends from a small end of the conical chamber to the nozzle. An annular conical passage is formed between the conical-shaped bottom end and the conical chamber. By adjusting the axial displacement of the adjusting shaft 7, the cross-sectional size of the annular conical passage is controlled, so as to adjust the flow rate. The separating needle extends into the nozzle 6 to create an annular jet spray pattern and expand the jet spray diameter.

The air inlet 2 is vertically disposed on one side of the cylindrical shell 1 orthogonal to the axis of the adjusting shaft, the liquid inlet 4 is disposed on the other side of the cylindrical shell 1 aligned to a tangential direction of the adjusting shaft 7, the top end of the gas path 8 is bent to connect to the airflow chamber 3, and the bottom end of the gas path 8 is connected to the mixed-flow chamber 5 through a forked path. The forked path at the lower end of the gas path 8 is disposed above the top side of the conical-shaped bottom end, and the fork openings of forked path are in an inclined arrangement, so as to optimize the mixing angle of the air flow and the liquid flow, improving the mixing turbulence.

The swirling flow path 9 is a groove helically provided around the outer periphery of the adjusting shaft 7, and the lower end of the swirling flow path 9 is disposed above the forked path. Water entering from the liquid inlet 4 flows downwards, which is guided by the swirling flow path 9, forming a helical swirling flow until it mixes with the gas ejected from the forked path. This increases the swirl intensity of the water flow, enhances the shearing action between water and air, and improves the fragmentation of water droplets, achieving a better atomization effect.

The locking assembly includes a fixing screw 10, a fixing plate provided at the top of the adjusting shaft 7, a fixing hole provided on the fixing plate, and a plurality of threaded holes provided on the top wall of the cylindrical shell 1. The fixing screw 10 successively crosses through the fixing hole and the threaded holes from top to bottom to form a thread engagement for locking. After rotating the adjusting shaft 7 to adjust to the appropriate height, the fixing hole is aligned and connected with any of threaded holes, and then the fixing screw 10 is inserted to tighten the adjusting shaft 7 to prevent from rotating, thereby securing the axial position of the adjusting shaft 7.

A magnet 11 is disposed at the bottom of the threaded holes, and the magnet 11 is fixed with the iron fixing screw 10 through magnetic attraction, so as to prevent the fixed bolt from falling off and causing the locking failure.

A flow gather hood 12 is disposed on the outer side of the cylindrical shell 1 at the nozzle 6. The flow gather hood 12 is conical-shaped and gradually expands downward from the cylinder shell 1, and a plurality of negative pressure suction ports 13 with a trapezoidal shape are arranged on the outer wall of the flow gather hood 12. The negative pressure suction ports 13 play a role in guiding and collecting dust. The high-speed ejected spray field will create a negative pressure field behind it, making surrounding dust-containing airflow through the negative pressure suction ports 13 enter into the flow gather hood 12. After the dust-containing airflow is mixed with the spray field, the probability of contact and collision between dust particles and the droplets is significantly increased. Dust particles are moistened and gain weight, undergoing sedimentation under the influence of gravity. This process enhances the dust removal efficiency of the nozzle, thereby improving the dust reduction efficiency.

### Embodiment 2

Based on Embodiment 1, the present embodiment is distinguished by the following:

The atomization method of the aperture-adjustable mixed-flow nozzle includes the following steps:
S1. introducing air through the air inlet 2 to allow the air flowing from the airflow chamber 3 into the gas path 8 and entering the mixed-flow chamber 5 through the forked path; introducing high-pressure water through the liquid inlet 4 to allow the high-pressure water entering the mixed-flow chamber 5 along a tangent line and being spiral descent guided by a swirling flow path 9; mixing the high-pressure water and the air thoroughly at between a conical-shaped bottom end of the adjusting shaft 7 and the conical chamber of the mixed-flow chamber 5; increasing a shearing force between gas and liquid through an inclined ejection angle of the air and a swirling angle of the high-pressure water, leading to gas-liquid atomization to form a jet spray droplets, and then ejecting the jet spray droplets through the nozzle 6. The above-mentioned mixed spray method enhances the atomization effect of the nozzle, and at the same time, the kinetic energy of the gas is increased, thereby enlarging the effective range of the spray field.
S2. if a flow passage between the conical-shaped bottom end of the adjusting shaft 7 and the conical chamber of the mixed-flow chamber 5 is blocked by debris (for example, large particles or plastic tape, etc.), pulling out the fixing screw through external force first, then rotating the adjusting shaft 7 to move the adjusting shaft upward along the axis of the cylindrical shell, gradually increasing a distance between the conical-shaped bottom end and the conical chamber, synchronously increasing the cross-sectional area of an annular conical channel, increasing the flow rate of the air and the high-pressure water, and then increasing the impact force to break through the debris, playing a role in unblocking and preventing blockage.
S3. pulling out the fixing screw with external force first when the atomization effect and the spray field condition are required to alter; then, rotating the adjusting shaft 7 to move the adjusting shaft along the axis of the cylindrical shell to adjust a flow rate of gas-liquid mixture to correspondingly modify air and water consumption, a spray pattern, and the atomization effect until a desired outcome is achieved; finally, reinserting the fixing screw to secure and lock position. The aforementioned method is suitable for complex dust-producing environments to enhance the dust reduction efficiency on-site.

In step S1, the jet spray droplets pass through the flow gather hood to form an umbrella-shaped jet constraint spray. The surrounding dust-containing airflow enters the flow gather hood through the negative pressure suction ports 13, the dust-containing airflow combines with the spray field to cause a collision of dust and jet spray droplets, and dust particles are moistened and gain weight, undergoing sedimentation under the influence of gravity, so as to achieve dust removal. The guided constraint is performed on the jet jet spray droplets by the flow gather hood 12, which is advantageous in reducing the ineffective dispersion of droplets, thereby minimizing the impact of wind disturbances on low-concentration droplets at the periphery of the spray field. The negative pressure suction ports 13 draws in dust-containing airflow, significantly increasing the probability of contact and collision between dust particles and droplets, thereby enhancing dust reduction efficiency.

Table 1 shows the comparison between the traditional nozzles and the present disclosure. Traditional nozzles, due to their built-in swirling core, often experience a reduced flow channel, making them prone to blockages and having a shorter lifespan. In contrast, the aperture-adjustable mixed-flow nozzle in the present disclosure avoids nozzle blockage issues, eliminating the need for frequent replacements and thereby improving operational efficiency and saving the costs. In terms of water consumption, traditional nozzles often install larger-aperture nozzles with higher water consumption to prevent blockages. The present disclosure effectively addresses blockage problems, allowing for adjustment to smaller apertures and lower water consumption at any time. Even when multiple nozzles are spraying simultaneously, water consumption is significantly lower than that of traditional nozzle types. Traditional nozzles commonly use non-adjustable high-pressure apertures, which are prone to blockages. After prolonged use, the water flow often tends to a columnar shape, resulting in lower dust reduction efficiency. In contrast, the present disclosure exhibits excellent atomization effects, a large effective range, adjustable water consumption, and adjustable atomization effects. Besides, the present disclosure is less prone to blockages, ensuring high dust reduction efficiency.

TABLE 1
Comparison between Traditional Nozzles
and the Present disclosure

| Parameter | Traditional nozzles | Present disclosure |
|---|---|---|
| Nozzle | In single-fluid nozzle, the | The aperture-adjustable |
| Replacement | built-in swirling core often | mixed-flow nozzle in the |
| Frequency | leads to a narrow flow | present disclosure avoids |
| | channel, making them prone | nozzle blockage issues, |
| | to blockages. In gas-liquid | eliminating the need for |
| | nozzle, due to their complex | frequent replacements, |
| | internal structure, it is also | thereby improving |
| | susceptible to blockages, | operational efficiency |
| | resulting in a shorter lifespan. | and saving the costs. |
| | In case of poor water quality, | The nozzle's lifespan |
| | nozzle replacement may be | exceeds 1 year. |
| | required every 1-2 weeks. | |
| Water | To avoid nozzle blockages, | It can effectively avoid |
| Consumption | larger-aperture nozzles with | nozzle blockage issues, |
| | higher water consumption are | allowing for adjustment |
| | often used on-site. When | to smaller apertures and |
| | multiple nozzles spray | lower water consumption |
| | simultaneously, water | at any time. Even with |
| | consumption is very high, | multiple nozzles spraying |
| | significantly impacting coal | simultaneously, water |
| | quality. | consumption is much lower |
| | | than traditional nozzle |
| | | types, greatly reducing the |
| | | impact on coal quality. |
| Spray Dust | Traditional high-pressure | Good atomization effect, |
| Removal | nozzles often have | large effective spray range, |
| Efficiency | non-adjustable apertures, are | adjustable water |
| | prone to blockages, and after | consumption, adjustable |
| | prolonged use, the water flow | atomization effect, less |
| | often becomes columnar, | prone to blockages. Dust |
| | resulting in dust removal | removal efficiency can |
| | efficiency generally below | reach 70% or more. |
| | 40%. | |

The above description is not a limitation of the present disclosure, and the present disclosure is not limited to the above examples, and the changes, modifications, additions or substitutions made by those skilled in the art within the essential scope of the present disclosure shall also fall within the scope of the present disclosure.

Although the terms including cylindrical shell 1, air inlet 2, airflow chamber 3, liquid inlet 4, mixed-flow chamber 5, nozzle 6, adjusting shaft 7, gas path 8, swirling flow path 9, fixing screw 10, magnet 11, conical hood 12, negative pressure suction port 13 are used frequently herein, the use of other terms is not excluded. The use of these terms is merely for the purpose of conveniently describing and explaining the essence of the present disclosure. Any interpretation of these terms as additional limitations would contradict the spirit of the disclosure.

What is claimed is:

1. An aperture-adjustable mixed-flow nozzle, comprising a cylindrical shell with an airflow chamber and a mixed-flow chamber that are separated at top and bottom, the airflow chamber is connected to an air inlet, and the mixed-flow chamber is connected to a liquid inlet, wherein an nozzle is provided at a bottom wall of the mixed-flow chamber on the cylindrical shell; the cylindrical shell allows airflow from the airflow chamber to enter the mixed-flow chamber through an adjusting shaft; a swirling flow path is disposed around an outer periphery of the adjusting shaft, and a gas path for connecting the airflow chamber and the mixed-flow chamber is disposed inside the adjusting shaft; the adjusting shaft is axially adjustable by extension and retraction along the cylindrical shell; and a locking assembly is provided between the adjusting shaft and the cylindrical shell.

2. The aperture-adjustable mixed-flow nozzle as claimed in claim 1, wherein the cylindrical shell is internally separated by a baffle plate to form the airflow chamber and the mixed-flow chamber; a first socket is arranged at a top wall of the airflow chamber on the cylindrical shell, and a second socket is correspondingly arranged on the baffle plate; and the adjusting shaft is connected with the first socket and the second socket in sequence to form a thread engagement assembly.

3. The aperture-adjustable mixed-flow nozzle as claimed in claim 2, wherein the mixed-flow chamber comprises a cylindrical chamber and a conical chamber that are interconnected with each other, with a small end of the conical chamber being connected to the nozzle; a bottom of the adjusting shaft is a conical-shaped bottom end, with a separating needle solidly disposed at the conical-shaped bottom end, and the separating needle extends from a small end of the conical chamber to the nozzle.

4. The aperture-adjustable mixed-flow nozzle as claimed in claim 3, wherein the air inlet is vertically disposed on one side of the cylindrical shell orthogonal to an axis of the adjusting shaft, the liquid inlet is disposed on the other side of the cylindrical shell aligned to a tangential direction of the adjusting shaft, a top end of the gas path is bent to connect to the airflow chamber, and a bottom end of the gas path is connected to the mixed-flow chamber through a forked path.

5. The aperture-adjustable mixed-flow nozzle as claimed in claim 4, wherein the swirling flow path is a groove helically provided around the outer periphery of the adjusting shaft, and a lower end of the swirling flow path is disposed above the forked path.

6. The aperture-adjustable mixed-flow nozzle as claimed in claim 1, wherein the locking assembly comprises a fixing screw, a fixing plate provided at a top of the adjusting shaft, a fixing hole provided on the fixing plate, and a plurality of threaded holes provided on a top wall of the cylindrical shell; the fixing screw successively crosses through the fixing hole and the threaded holes from top to bottom to form a thread engagement for locking.

7. The aperture-adjustable mixed-flow nozzle as claimed in claim 6, wherein a magnet is disposed at a bottom of the threaded holes, and the magnet is fixed with the fixing screw through magnetic attraction.

8. The aperture-adjustable mixed-flow nozzle as claimed in claim 1, wherein a flow gather hood is disposed on an outer side of the cylindrical shell at the nozzle; the flow gather hood is conical-shaped and gradually expands downward from the cylinder shell; and a plurality of negative pressure suction ports with a trapezoidal shape are arranged on the outer wall of the flow gather hood.

9. The atomization method of the aperture-adjustable mixed-flow nozzle, comprising:
S1. introducing air through an air inlet to allow the air flowing from an airflow chamber into the gas path and entering a mixed-flow chamber through a forked path; introducing high-pressure water through a liquid inlet to allow the high-pressure water entering the mixed-flow chamber along a tangent line and being spiral descent guided by a swirling flow path; mixing the high-pressure water and the air thoroughly at between a conical-shaped bottom end of an adjusting shaft and a conical chamber of the mixed-flow chamber; increasing a shearing force between gas and liquid through an inclined ejection angle of the air and a swirling angle of the high-pressure water, leading to gas-liquid atomization to form a jet spray droplets, and then ejecting the jet spray droplets through a nozzle;
S2. if a flow passage between the conical-shaped bottom end of the adjusting shaft and the conical chamber of the mixed-flow chamber is blocked by debris, pulling out the fixing screw through external force first, then rotating the adjusting shaft to move the adjusting shaft upward along an axis of a cylinder shell, gradually increasing a distance between the conical-shaped bottom end and the conical chamber, synchronously increasing the cross-sectional area of an annular conical channel, increasing a flow rate of the air and the high-pressure water, and then increasing a impact force to break through the debris, playing a role in unblocking and preventing blockage;
S3. pulling out the fixing screw with external force first when an atomization effect and a spray field condition are required to alter; then, rotating the adjusting shaft to move the adjusting shaft along its axis to adjust a flow rate of gas-liquid mixture to correspondingly modify air and water consumption, a spray pattern, and the atomization effect until a desired outcome is achieved; finally, reinserting the fixing screw to secure and lock position.

10. The atomization method of the aperture adjustable mixed-flow nozzle as claimed in claim 9, wherein in step S1, the jet spray droplets pass through the flow gather hood to form an umbrella-shaped jet constraint spray; the surrounding dust-containing airflow enters the flow gather hood through the negative pressure suction ports, the dust-containing airflow combines with the spray field to cause a collision of dust and jet spray droplets, and dust particles are moistened and gain weight, undergoing sedimentation under an influence of gravity, so as to achieve dust removal.
